(19) United States
(12) Patent Application Publication
(10) Pub. No.: US 2019/0376231 A1
(43) Pub. Date: Dec. 12, 2019

(54) FOLDING SYSTEM

(71) Applicant: Miller Weldmaster Corporation, Navarre, OH (US)

(72) Inventors: Brian D. Henry, North Lawrence, OH (US); Zachary J. Ralston, Canton, OH (US)

(21) Appl. No.: 16/546,445

(22) Filed: Aug. 21, 2019

Related U.S. Application Data
(63) Continuation-in-part of application No. 16/124,726, filed on Sep. 7, 2018.
Application No. 16/124,726 is a continuation of application No. 14/861,475, filed on Sep. 22, 2015, now Pat. No. 10,081,907.
Application No. 14/861,475 is a division of application No. 14/071,143, filed on Nov. 4, 2013, now Pat. No. 9,169,595.
(60) Provisional application No. 61/722,432, filed on Nov. 5, 2012.

(51) Int. Cl. D06H 5/00; B29C 65/18; B29C 65/78; B29C 65/00; B29C 53/36

(52) U.S. Cl. CPC D06H 5/00; B29C 65/18; B29C 65/7835; B29C 65/7841; B29C 66/135; B29C 66/431; B29C 2053/362; B29C 66/8322; B29C 53/36; B29C 66/1122; B29C 66/729; B29C 66/845; Y10T 156/1051; B29C 66/8242

(57) ABSTRACT

A machine and method for welding sheets of plastic material. The machine includes a housing with a lower weld bar and an upper weld bar. A vertically-oriented gap is defined in a gripper assembly pivotally mounted to the housing beneath the work surface. A sheet of material is laid over the work surface covering the lower weld bar and gap. The upper weld bar is lowered to hold the sheet in place and a pusher plate is lowered relative to the upper weld bar to push some material into the gap, thereby creating a fold in the material. After withdrawing the upper weld bar and pusher plate, the gripper assembly is pivoted through ninety degrees and lays some of the folded material over the lower weld bar. The upper weld bar is lowered to weld a portion of the folded material and thereby create a pocket in the material.

### CROSS REFERENCE TO RELATED APPLICATIONS

This application is a continuation-in-part of U.S. patent application Ser. No. 16/124,726, filed Sep. 7, 2018, which is a continuation of U.S. patent application Ser. No. 14/861,475 filed Sep. 22, 2015, now U.S. Pat. No. 10,081,907, which is a divisional of U.S. patent application Ser. No. 14/071,143, filed Nov. 4, 2013, now U.S. Pat. No. 9,169,595, which claims the benefit of U.S. Provisional Patent Application Ser. No. 61/722,432, filed Nov. 5, 2012; the disclosures of which are incorporated herein by reference.

### BACKGROUND

### Technical Field

The present disclosure relates generally to apparatus, systems, and methods for creating pockets, hems, seams, and overlaps on plastic fabrics or textiles. More particularly, the apparatus, systems and methods relate to creating pockets, hems, seams, and overlaps on plastic fabrics utilizing heat-welding. Specifically, the apparatus, systems and methods automatically fold and weld a pocket proximate an edge of a plastic fabric by pushing a portion of the fabric into a gap with a pusher plate of a folding assembly, pivoting the folding assembly to lay a portion of the folded fabric back on itself, moving a welding bar into contact with the folded fabric, and then applying heat and pressure to create the weld.

### Background Information

The creation of a hem along an edge of a sheet of material is well known in the art. In an effort to reinforce fabric around its perimeter, an edge of the fabric is folded back onto the sheet of material and is secured to that sheet. By so doing, at least a portion of the perimeter of the sheet of material is reinforced in that the perimeter is twice the thickness relative to the rest of the sheet of fabric. This provides for a fabric that can be used in awnings and signage that has reinforced edges that can now better withstand weather and wind. Additionally, an elongated pocket can be formed by not completely attaching all of the folded fabric to the underlying sheet of fabric. This allows an elongated structure, such as a rod or a rope, to be inserted into the pocket. The rod or rope can be then be used to hang the fabric sheet or to secure the sheet to some other structure. This enables the fabric to be used as signage or allows the fabric to be mounted to a frame for use in awning applications. Current methods of manipulating fabric and welding/connecting the folded material to the main sheet of fabric can be labor intensive as plastic fabric is difficult to manipulate. Therefore, a better way of creating a fold at an edge of a sheet of fabric is desired.

### SUMMARY

The folding system disclosed herein is contemplated to be used for multiple purposes including but not limited to welding seams, hems, or pockets for awnings, screens, blinds, and marine products. The folding system is a welding machine that may be utilized to weld a wide variety of different plastic fabrics and textiles. The welding machine is able to be operated by a single operator.

A machine for welding sheets of a plastic material and a method of use thereof is disclosed herein. The machine includes a housing with a lower weld bar and an upper weld bar. A vertically-oriented gap is defined in a gripper assembly pivotally mounted to the housing beneath the work surface. A sheet of material is laid over the work surface covering the lower weld bar and gap. The upper weld bar is lowered to hold the sheet in place and a pusher plate is lowered relative to the upper weld bar to push some material into the gap, thereby creating a fold in the material. After withdrawing the upper weld bar and pusher plate, the gripper assembly is pivoted through ninety degrees and lays some of the folded material over the lower weld bar. The upper weld bar is lowered to weld a portion of the folded material and thereby create a pocket in the material.

In one aspect, an exemplary embodiment of the present disclosure may provide a machine for welding a sheet of plastic material comprising a housing; a lower weld bar fixedly secured to the housing; an upper weld bar secured to the housing a distance above the lower weld bar; said upper weld bar being vertically movable up and down relative to the lower weld bar; a gap defined in the work surface proximate the lower weld bar; and a pusher plate mounted proximate the upper weld bar and being selectively movable up and down relative to the upper weld bar; wherein said pusher plate is vertically aligned with the gap and is selectively receivable in the gap.

In one example, the gap is selectively variable in width. In one example, the gap is part of a gripper assembly and is defined between a front plate and a clamping plate; wherein the front plate and clamping plate are oriented parallel to each other and at right angles to the work surface; and wherein the clamping plate is movable relative to the front plate. The welding machine further comprises an actuator operatively engaged with the front plate; and wherein the front plate is pivotally engaged with the work surface; and wherein the actuator is selectively operable to move the front plate between a first vertical position and a second horizontal position. In one example the gripper assembly further comprises a rear plate spaced from the front plate and fixedly engaged therewith, wherein a gap is defined between the front plate and the rear plate; and wherein the clamping plate is located in the gap. The actuator pivots the rear plate, the front plate, and the clamping plate in unison. In one example, the welding machine further includes one or more first actuators engaged with the clamping plate, said one or more actuators being are operable to move the clamping plate one of toward the front plate and away from the front plate and thereby change a width of the gap.

In one example, the welding machine further comprises an upper beam provided on the housing; wherein the upper weld bar is located in the upper beam and wherein the welding machine further comprises a translation mechanism operatively engaging the pusher plate to the upper beam, wherein the translation mechanism selectively raises and lowers the pusher plate relative to the upper beam. A fabric position stop is provided on the work surface, said fabric position stop being selectively horizontally movable across the work surface toward and away from the lower weld bar.

In another aspect, an exemplary embodiment of the present disclosure may provide a method of forming a fold or a pocket in a sheet of plastic material, said method comprising defining a gap in a work surface; placing a sheet of plastic material over an opening to the gap, wherein the opening is defined in the work surface; moving a pusher plate into contact with a region of the sheet of plastic material that extends over the opening; moving the pusher plate inwardly into the gap; and creating a fold in the sheet of plastic material as the pusher plate moves inwardly into the gap.

In one example, the defining of the gap comprises defining a vertically-oriented gap in the work surface; and the providing of the pusher plate comprises providing a vertically-oriented pusher plate that is aligned with the vertically-oriented gap. In one example, the defining of the gap comprises providing a front plate having a front surface and a rear surface that are oriented at right angles to the work surface; providing a clamping plate having a front surface and a rear surface that are oriented at right angles to the work surface; and the gap is defined between the rear surface of the front plate and the front surface of the clamping plate; and wherein the method further comprises inserting the pusher plate between the front surface of the clamping plate and the rear surface of the front plate.

In one example the method further comprises inserting the pusher plate into the gap when the gap is set at a first width; withdrawing the pusher plate from the gap when the fold has been created in the sheet of plastic material; reducing the first width of the gap to a second width; and clamping the fold between the front plate and the clamping plate. In one example, the reducing of the first width of the gap includes activating one or more actuators engaged with the clamping plate; and moving the clamping plate toward the front plate. The moving of the clamping plate toward the front plate includes keeping the clamping plate parallel to the front plate.

In one example, the method further comprises rotating the clamping plate, the front plate and the fold in the sheet of plastic material from a vertical orientation to a horizontal orientation. In one example, the method further includes placing a portion of the fold that extends outwardly from the gap onto an upper surface of the sheet of plastic material and over a lower weld bar; moving an upper weld bar into contact with the portion of the fold; and heat-welding the portion of the fold to the upper surface of the sheet of plastic material.

In one example the method further comprises determining a depth of the pusher plate into the gap relative to an axis of rotation of the front plate; and selecting the depth of the pusher plate so that when rotation of the front plate occurs, a portion of the fold extends outwardly beyond an end wall of the front plate. In one example the method includes abutting an edge of the sheet of plastic material on the work surface against a face of a fabric position stop prior to moving the pusher plate into the gap. The method further includes adjusting a location of the fabric position stop on the work surface prior to abutting the edge of the sheet of plastic material against the end face

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front elevation view of a folding system in accordance with an aspect of the present disclosure;

FIG. 2 is a right side elevation view of the folding system taken along line 2-2 of FIG. 1;

FIG. 2A is an enlarged right side elevation view of the highlighted region of FIG. 2;

FIG. 3 is a rear elevation view of the folding system of FIG. 1;

FIG. 3A is an enlarged rear elevation view of a first highlighted region of FIG. 3;

FIG. 3B is an enlarged rear elevation view of a second highlighted region of FIG. 3;

FIG. 4A is a top plan view taken along line 4A-4A of FIG. 3;

FIG. 4B is a top plan view taken along line 4B-4B of FIG. 3;

FIG. 4C is a top plan view taken along line 4C-4C of FIG. 3;

FIG. 5 is a side elevation view taken along line 5-5 of FIG. 4A;

FIG. 6 is a side elevation view taken along line 6-6 of FIG.4C but with the shaft omitted for clarity of illustration;

FIG. 7 is a side elevation view taken along line 7-7 of FIG. 4C but with the shaft omitted for clarity of illustration;

FIG. 8 is partial top plan view of the lower housing of the folding system taken from below an upper weld bar and looking down at the lower housing; the view shows a portion of the lower housing from a center line “CL” thereof to a region adjacent a right end support; the opposite portion of the lower housing is a mirror image thereof;

FIG. 9 is side elevation view taken along line 9-9 of FIG. 3B;

FIG. 10 is side elevation view taken along line 10-10 of FIG. 8;

FIG. 11 is a side elevation view taken along line 11-11 of FIG. 3B;

FIG. 12 is a side elevation view taken along line 12-12 of FIG. 3B;

FIG. 13 is a side elevation view taken along line 13-13 of FIG. 3B;

FIG. 14 is a side elevation view similar to FIG. 13 showing an end region of a sheet of fabric being inserted into the folding system until an edge thereof contacts a fabric position stop, and showing the upper welding assembly moving into contact therewith;

FIG. 15 is a side elevation view similar to FIG. 14 showing the folding assembly moving downwardly relative to the upper welding assembly and creating a fold in the fabric;

FIG. 16 is a side elevation view similar to FIG. 15 showing the upper housing moving upwardly away from the lower housing, and showing the clamping plate being moved forwardly to clamp the section of folded fabric;

FIG. 17 is a side elevation view similar to FIG. 16 showing the fold assembly pivoting from a neutral position to a welding position and thereby positioning the section of folded fabric for welding;

FIG. 18 is a side elevation view similar to FIG. 17 showing the upper welding assembly moving downwardly to position the upper weld bar in contact with the lower weld bar;

FIG. 19 is a side elevation view similar to FIG. 18 showing the upper welding assembly being moved upwardly away from the lower housing, and showing the welded fabric being removed from the system; and

FIG. 20 is a side elevation view similar to FIG. 19 showing the fold assembly pivoting back to the neutral position.

Similar numbers refer to similar parts throughout the drawings.

### DETAILED DESCRIPTION

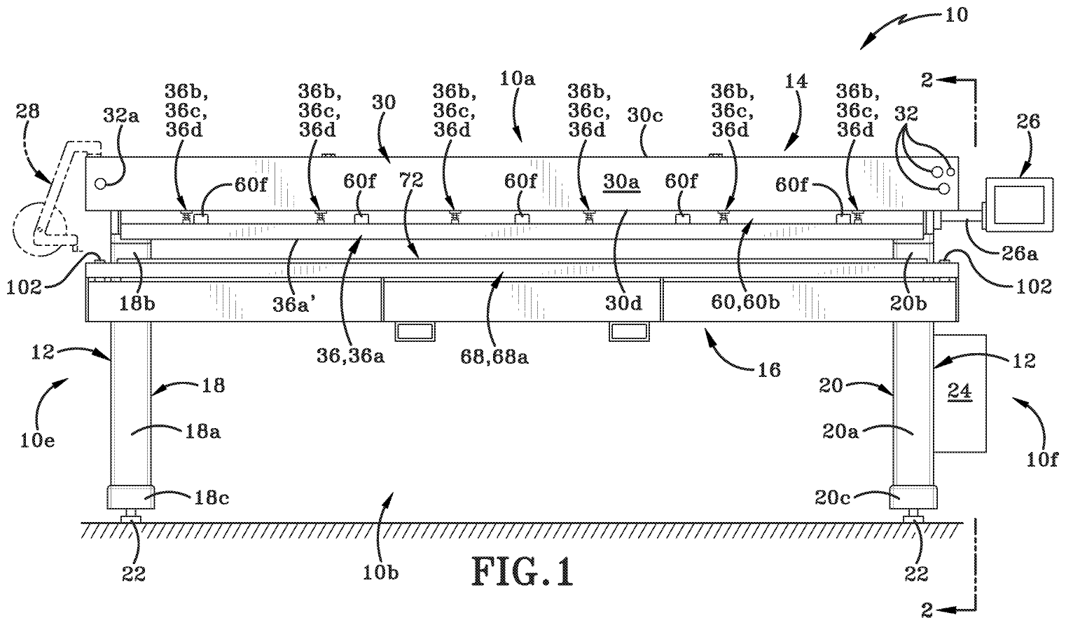

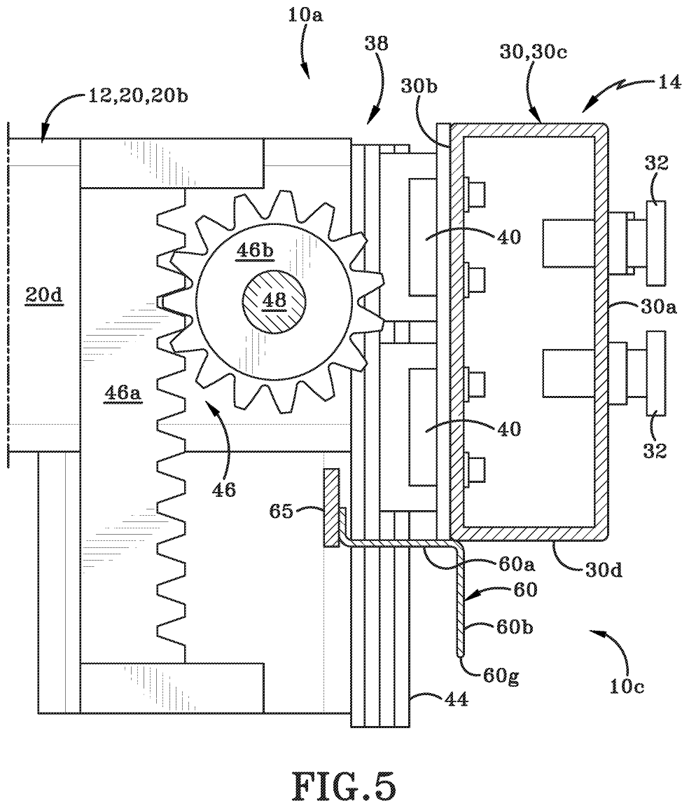

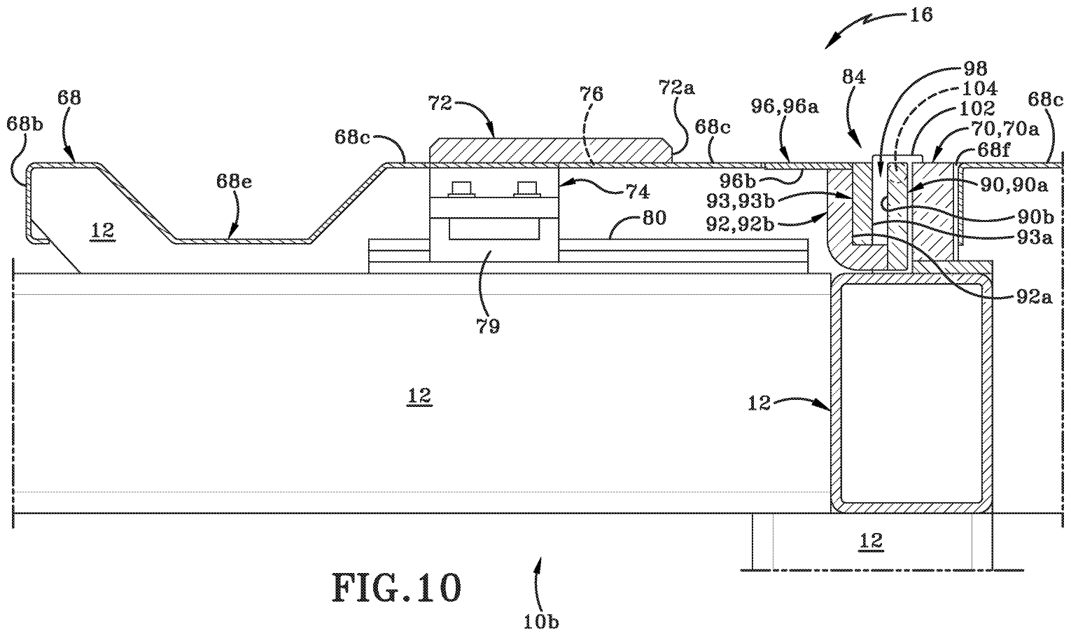

Referring to FIGS. 1 through 20 there is shown a folding system in accordance with an aspect of the present disclosure. In particular, the folding system comprises a welding machine 10 that may be used to create folds in a sheet of fabric. In particular the sheet of fabric is a sheet of a plastic fabric that is suitable for heat-welding.

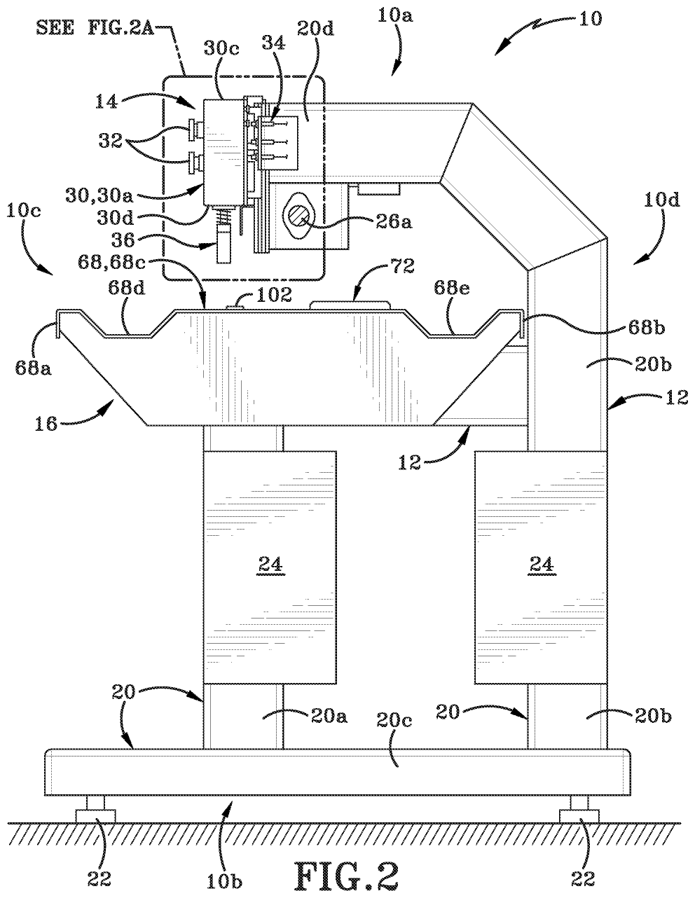

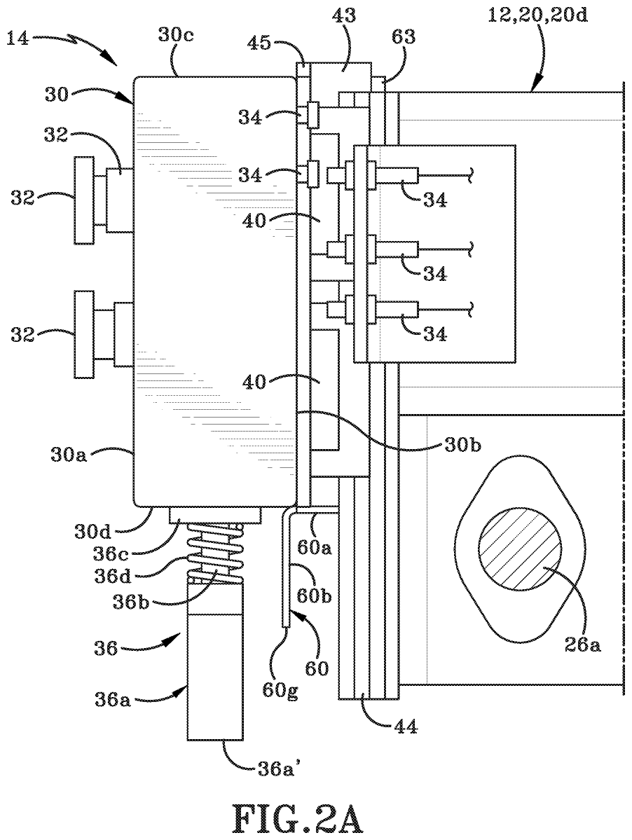

Referring to FIGS. 1 and 2, welding machine 10 includes a housing having a top 10a, a bottom 10b, a front 10c, a rear 10d, a left side 10e, and a right side 10f. Top 10a and bottom 10b define a vertical direction therebetween. Front 10c and rear 10d define a lateral direction therebetween. Left side 10e and right side 10f define a longitudinal direction therebetween. The front 10c is a region of welding machine 10 proximate which a single operator will stand in order to perform a welding operation on a fabric sheet.

The housing of welding machine 10 includes a frame 12 that supports an upper housing 14 and a lower housing 16. Frame 12 holds upper housing 14 a distance vertically above lower housing 16. At least a portion of upper housing 14 is selectively movable downwardly toward lower housing 16 or upwardly away from lower housing 16. The portion of the upper housing 14 is moved downwardly in order to create a fold in a sheet of fabric and/or to perform a welding operation on the sheet of fabric.

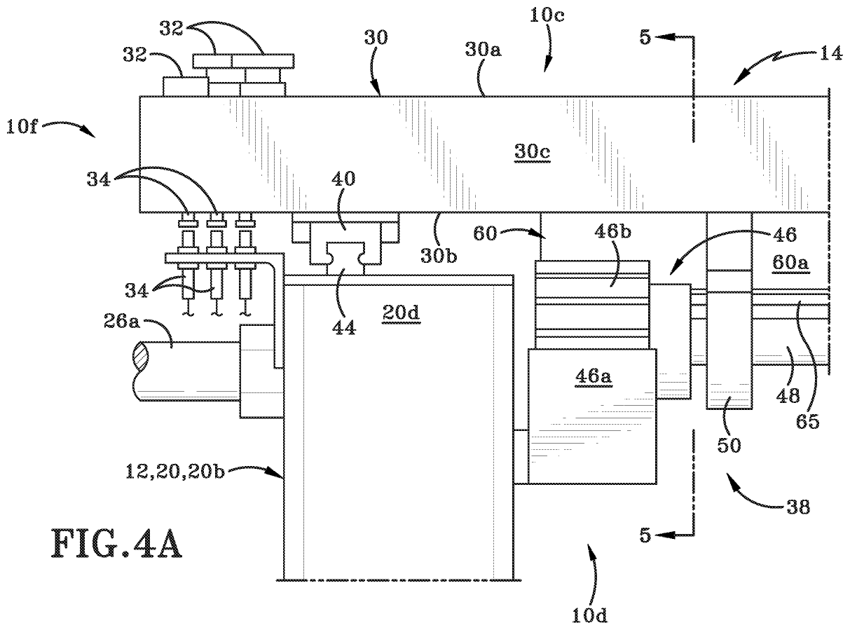

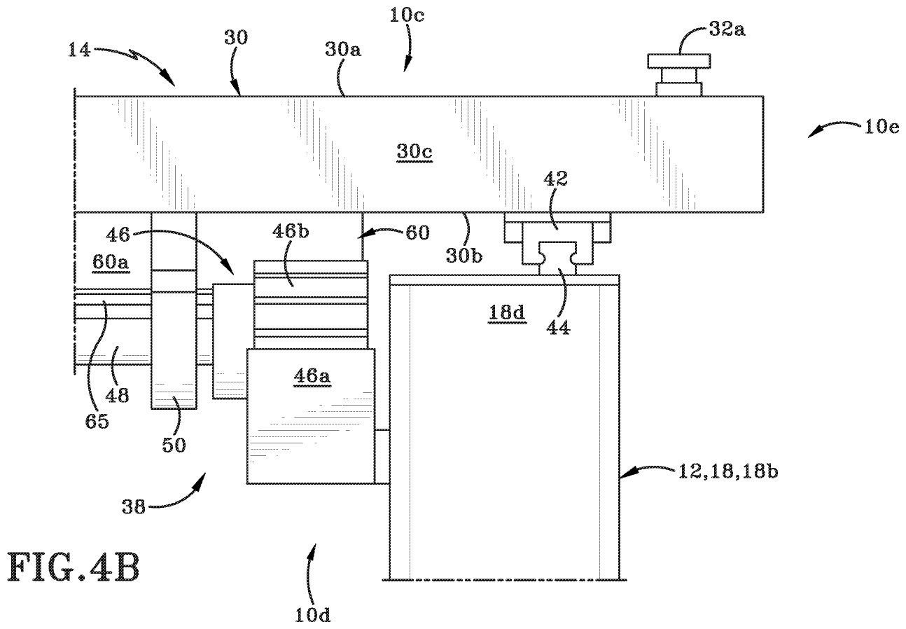

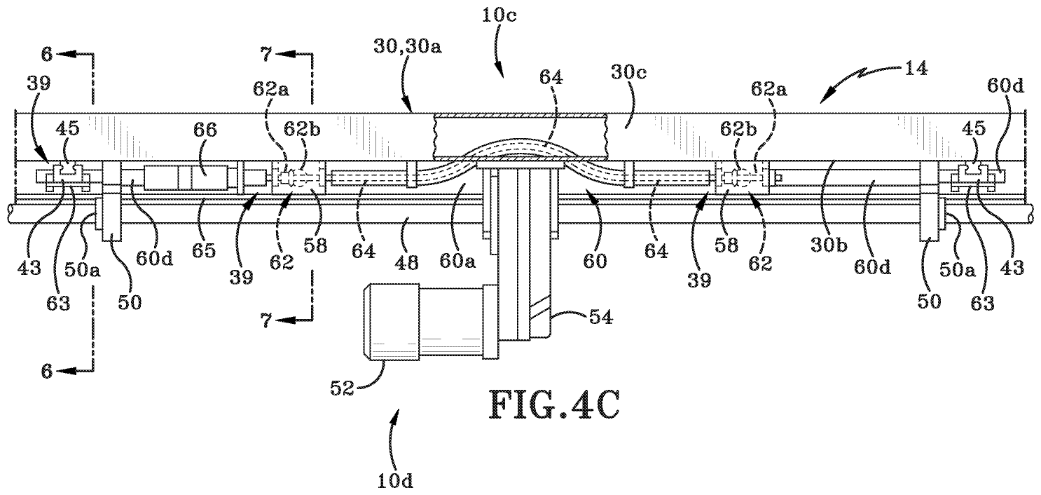

Frame 12 is comprised of a plurality of different members, only some of which are illustrated in the figures for clarity of illustration. As illustrated in the attached figures, frame 12 includes a first end support 18 and a second end support 20 that are longitudinally spaced a distance apart from each other. The first and second end supports 18, 20 are substantially identical in structure and function and will be described hereafter in greater detail. First end support 18 includes a first leg 18a and a second leg 18b that are connected to each other via crossbars 18c. Both of first leg 18a and second leg 18b are generally vertically oriented and second leg 18b is located a distance rearwardly from first leg 18a. First leg 18a and second leg 18b may be laterally aligned with each other. First leg 18a is engaged with a front region of lower housing 16 and second leg 18b is engaged with a rear region of lower housing 16. A portion of second leg 18b extends upwardly beyond lower housing 16 and has an inverted “J-shape” or inverted “L-shape”. A terminal end 18d (FIG. 4B) of the second leg 18b is engaged with the upper housing 14. The second leg 18b maintains the upper housing 14 vertically above lower housing 16.

In a similar fashion, second end support 20 includes a first leg 20a and a second leg 20b that are engaged with each other via crossbars 20c. Both of first leg 20a and second leg 20b are generally vertically oriented and second leg 20b is located a distance rearwardly from first leg 20a and may be laterally aligned therewith. First leg 20a is engaged with a front region of lower housing 16 and second leg 20b is engaged with a rear region of lower housing 16. A portion of second leg 20b extends upwardly beyond lower weld bar and may have an inverted “J-shape” or inverted “L-shape” as is best seen in FIG. 2. A terminal end 20d of the second leg 20b is secured to the upper housing 14 and helps to maintain upper housing 14 in a position vertically above lower housing 16.

It will be understood that in one example, first leg 18a and first leg 20a are longitudinally aligned with each other; and second leg 18b and second leg 20b are longitudinally aligned with each other. It will further be understood that various side panels and guard plates may be engaged with various parts of the frame to limit access and protect the operator. Most of these components have been omitted from the figures for clarity of illustration.

FIGS. 1 and 2 show that pedestals 22 extend downwardly from each of the first and second legs 18a, 18b, 20a, 20b and contact a floor surface “FS” upon which welding machine 10 sits. Pedestals 22 may be of a type that is adjustable so that welding machine 10 may be leveled off. In other instances, wheels may be used instead of or in addition to pedestals 22. In yet other instances the pedestals 22 or wheels may be omitted from welding machine 10.

Various components of welding machine 10 may be supported or carried by first legs 18a, 20a, and/or second legs 18b, 20b. For example, one or more transformers 24 are illustrated as being engaged with first and second legs 20a, 20b. Additionally, a user interface 26 is illustrated as being engaged with terminal end 20d of second leg 20b via a pivot assembly 26a. The pivot assembly 26a permits an operator to pivot the user interface 26 relative to terminal end 20d. The operator is able to orient the user interface to a desired position suitable for entering and viewing information on the user interface 26. In one example, user interface 26 is provided with controller logic useful for operating welding machine 10. “Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logical logics into one physical logic. Similarly, where a single logical logic is described, it may be possible to distribute that single logic between multiple physical logics. The operator may enter control parameters into user interface 26 prior to and/or during a welding operation by using a touch screen or other controls provided on interface 26.

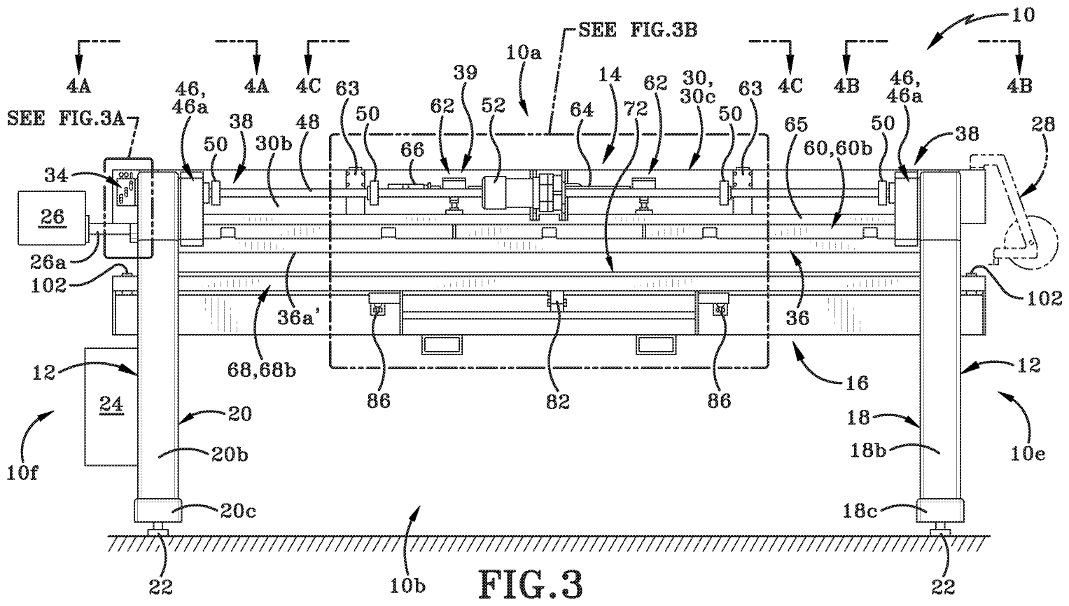

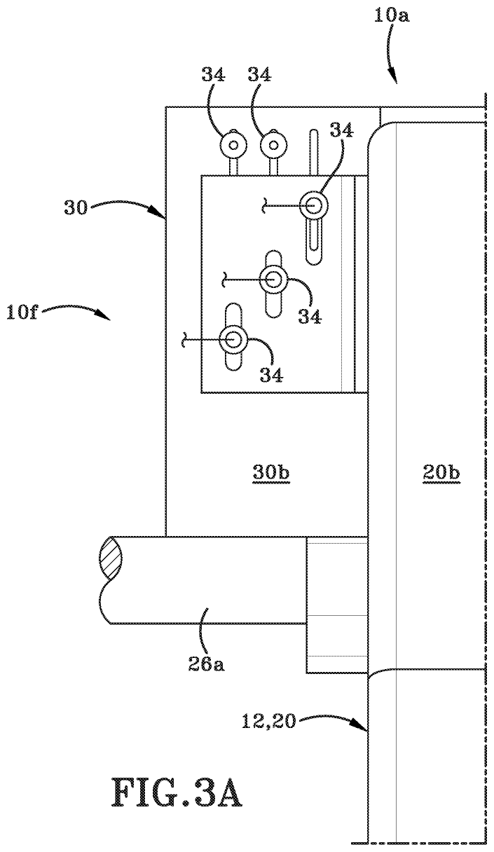

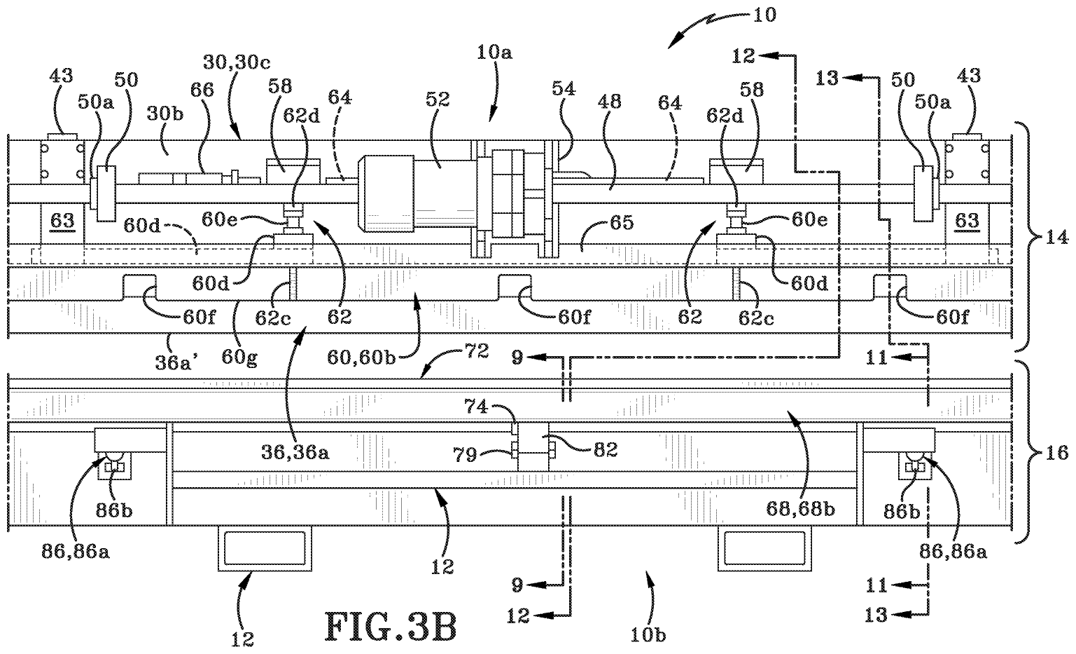

Another component that may be engaged with one of the first and second legs 18, 20, or with an upper beam 30 (FIGS. 2A and 3) is a tape dispenser assembly 28, illustrated in phantom. Tape dispenser assembly 28 is configured to hold a roll of bonding tape thereon and lengths of bonding tape may be withdrawn from tape dispenser assembly 28 and across fabric placed on lower housing 16. The bonding tape may be utilized to help bond the fabrics being welded to each other.

Referring now to FIGS. 1-20, upper housing 14 will be described in greater detail. Upper beam 30 is part of upper housing 14 and includes a front surface 30a, a rear surface 30b, a top surface 30c, and a bottom surface 30d. One end of upper beam 30 engages terminal end 18d of left end support 18 and an opposed end of upper beam 30 engages terminal end 20d of right end support 20. Upper beam 30 therefore extends longitudinally between second legs 18b and 20b.

Upper housing 14 further includes an upper welding assembly 36 that is engaged with upper beam 30 and extends downwardly from bottom surface 30d thereof. The upper welding assembly 36 will be described in greater detail hereafter. A plurality of controls 32 and sensors 34 are provided on upper beam 30. Controls 32 are illustrated as being mounted on front surface 30a and sensors 34 are illustrated as being mounted on rear surface 30b thereof. It will be understood, however, that the controls 32 and sensors 34 may be provided at any suitable location on welding machine 10.

Controls 32 may include any desired buttons and/or switches for controlling various aspects of welding machine 10. For instance, controls 32 are provided proximate right end support 20 and include but are not limited to an emergency shut-off button, a pause button, and a reset button. Similar controls 32a (FIG. 1) may be provided on an opposite end of upper housing 14 (i.e., proximate left end support 18) so that an operator or another person may readily reach an emergency shut-off button and/or pause button without having to move to the opposite end of welding machine 10. Controls 32 may further include a switch for switching a laser beam on or off to direct the operator to a position when an end of the fabric to be welded should be place or where a fold will be created in the fabric. Controls 32 may further include a switch for activating Light Emitting Diodes (LEDs) on the underside of upper housing 14 to selectively illuminate the upper surface of lower housing 16 during operation of welding machine 10. The sensors 34 provided on upper beam 30 may include heat sensors, light sensors, proximity sensors, etc.

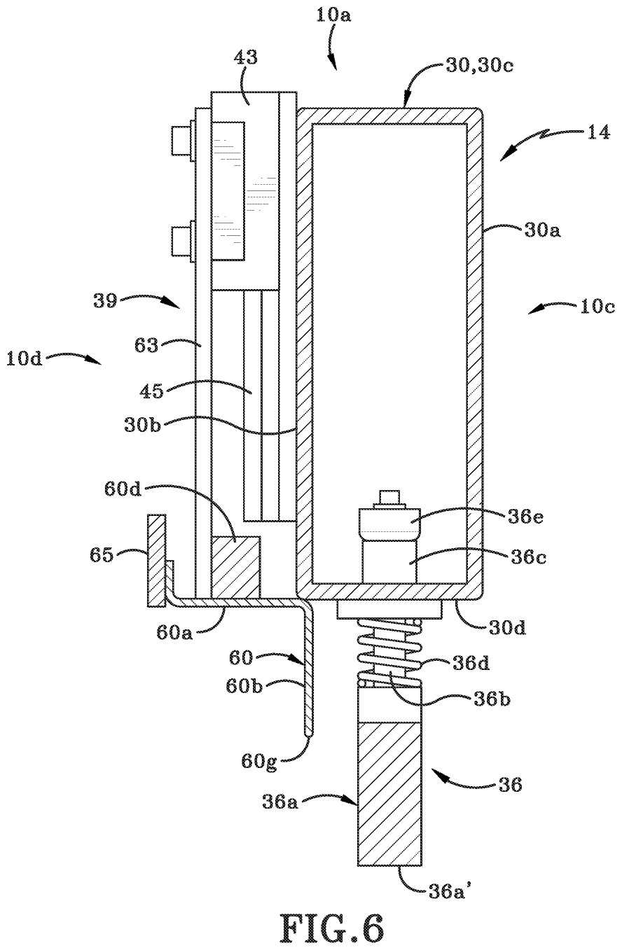

Upper housing 14 further includes an upper welding assembly 36. Referring to FIGS. 2A and 6, upper welding assembly 36 includes an upper weld bar 36a that is engaged with upper beam 30 by way of a plurality of shafts 36b and associated guide bushings 36c and stops 36e. Upper weld bar 36a is an elongate member that is configured to extend from proximate left end support 18 to right end support 20. Upper weld bar 36a includes a lower surface 36a′ that is oriented substantially parallel to bottom surface 30d of upper beam 30. A coil spring 36d is positioned around each shaft 36b and between guide bushing 36c and upper weld bar 36a. Coil springs 36d are compressed when upper beam 30 is moved downwardly so that upper weld bar 36a contacts lower housing 16. Springs 36d return to their expanded state when upper beam 30 is moved upwardly away from lower housing 16 and contact is broken between upper weld bar 36a and lower housing 16. Upper weld bar 36a is operatively engaged with user interface 26 and is configured to heat up to a desired temperature and to apply and pre-determined pressure for a predetermined time.

Upper beam 30 is able to be moved upwardly and downwardly relative to lower housing 16 so as to be able to move upper weld bar 36a into contact with a lower weld bar that will be described later herein. A lowering mechanism 38 (FIGS. 3, 4A, 4B and 5) is provided for effecting movement of upper beam 30. Lowering mechanism 38 includes a pair of guide blocks 40, 42 (FIGS. 4A and 4B) mounted proximate opposite ends of upper beam 30. A guide rail 44 is provided on a front face of terminal ends 18d, 20d adjacent a gear housings 46. Guide blocks 40, 42 matingly engage with guide rails 44 and are able to ride up and down therealong. A gear rack 46a is provided on the terminal end 18d, 20d of each second leg 18b, 20b. Each end of a drive shaft 48 is operatively engaged with a gear 46 and one of the gear housings 46 and a plurality of bearing blocks 50 and associated stop rings 50a secure drive shaft 48 to upper beam 30 while permitting drive shaft 48 to be rotated about an axis extending along shaft 48. Each gear 46b is configured to mesh with one of the gear racks 46a. A motor 52 is secured to upper beam 30 by way of a mounting 54 and is utilized to drive the drive shaft 48. As the motor 52 rotates the drive shaft in a first direction, the upper beam 30 moves downwardly toward the lower housing 16. When the motor 52 rotates in the opposite direction, the upper beam moves upwardly away from lower housing 16.

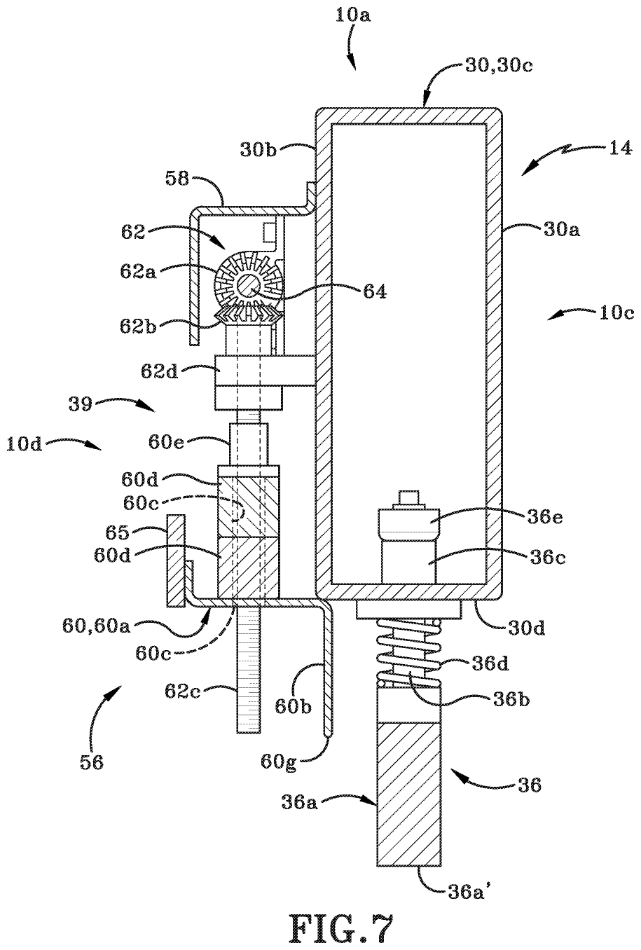

Referring to FIG. 7, upper housing 14 further includes an upper folding assembly 56 that is operatively engaged with upper beam 30 in such a way that at least a portion of upper folding assembly 56 is able to move upwardly or downwardly relative to bottom surface 30c of upper beam 30. Upper folding assembly 56 includes a shield 58 and a lower bracket 60. Shield 58 is secured to upper beam 30 and protects the mechanisms below it. Lower bracket 60 includes a horizontally-oriented leg 60a and a vertically-oriented leg 60b. The vertically-oriented leg 60b will be referred to hereinafter as pusher plate 60b. An aperture 60c (FIG. 7) is defined in horizontal support plate 60a and through connector block 60d.

Upper housing 14 further includes a flexible drive shaft 64 (FIG. 4C) that is threaded through apertures defined in rear surface 30b of upper beam 30 and through a portion of the hollow interior of upper beam 30. A stepper motor 66 is provided to rotate drive shaft 64 about an axis that extends along drive shaft 64. The drive shaft 64 is operatively engaged with a first gear 62a (FIG. 7) of each of the translation mechanisms 62. First gear 62a is operatively engaged with second gear 62b which in turn is engaged with a threaded rod 62c. When second gear 62b rotates, threaded rod 62c is rotated. Rod 62c passes through a bore of a support 62d and subsequently into a bore of a thread follower 60e. Threaded rod 62c extends through a bore of a connector block 60d that extends upwardly from plate 60a of upper folding assembly 56 and subsequently through a threaded bore of a thread follower 60e. As threaded rod 62c rotates in a first direction, lower bracket 60 (and thereby pusher plate 60b) is moved vertically upwardly relative to bottom surface 30d of upper beam 30. When threaded rod 62c is rotated in a second direction, lower bracket 60 (and thereby pusher plate 60b) is moved vertically downwardly relative to bottom surface 30d of upper beam 30A. FIGS. 4C and 6 show a lowering mechanism 39 for lowering lower bracket 60 relative to upper beam 30. FIGS. 3B and 6 shows that an outermost end of lower bracket 60 is supported by a plate 63 that is secured to guide block 43 which is able to travel up and down a guide rail 45 provided proximate bearing blocks 50a engaged with rear surface 30b of upper beam 30. A similar plate 63, guide block 43 and guide rail 45 is provided on the opposite end of upper beam 30 and lower bracket 60. FIGS. 6 and 7 also show that a strengthening plate 65 secured to lower bracket 60 a spaced distance outwardly from plate 63. Strengthening plate 65 extends from one end of lower bracket 60 to the other. The plates 63, 65 help to keep folding assembly moving smoothly upwardly or downwardly relative to upper beam 30.

It will be understood that a guard plate is engaged with front surface 30a of upper beam 30 and extends downwardly for a distance below bottom surface 30d thereof. The guard plate is provided is prevent access and contact with upper weld bar 36a during a welding operation. The guard plate preferably is transparent so that an operator can observe the welding operation occurring behind the guard plate.

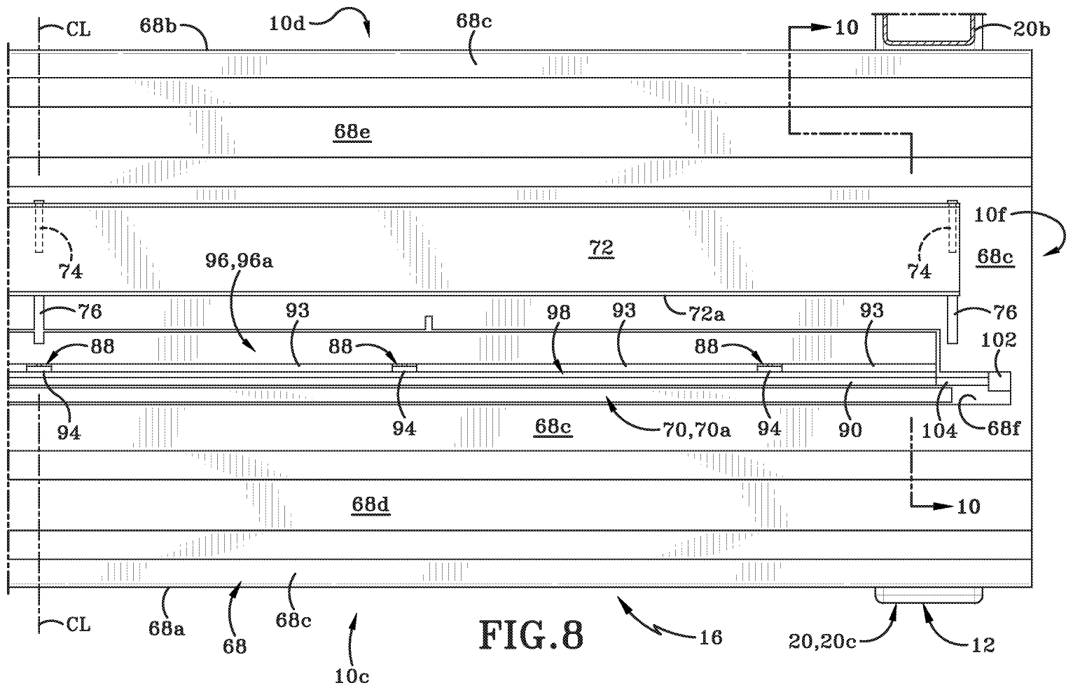

Referring now to FIGS. 1, 2 and 9-20, lower housing 16 will be described in greater detail. Lower housing 16 includes a central region 68c that has a front 68a, a back 68b a central region 68c with two elongated and parallel troughs 68d, 68e defined therein. A first trough 68d of the two troughs is located between front 68a and central region 68c. A second trough 68d of the two troughs is located between rear 68b and central region 68c. First and second troughs 68d, 68e are both oriented parallel to a longitudinal axis of welding machine 10 where the longitudinal axis is oriented at right angles and extends between left end support 18 and right end support 20. Each trough 68d, 68e extends downwardly from central region 68c and may be generally U-shaped as shown in FIG. 2. Troughs 68d, 68e provide an area into which a quantity of sheet fabric may easily be manipulated/stored during the process of creating a fold and weld in the fabric, as will be discussed later herein. As best seen in FIGS. 8 & 17, a longitudinally-oriented gap 68f is defined in central region 68c.

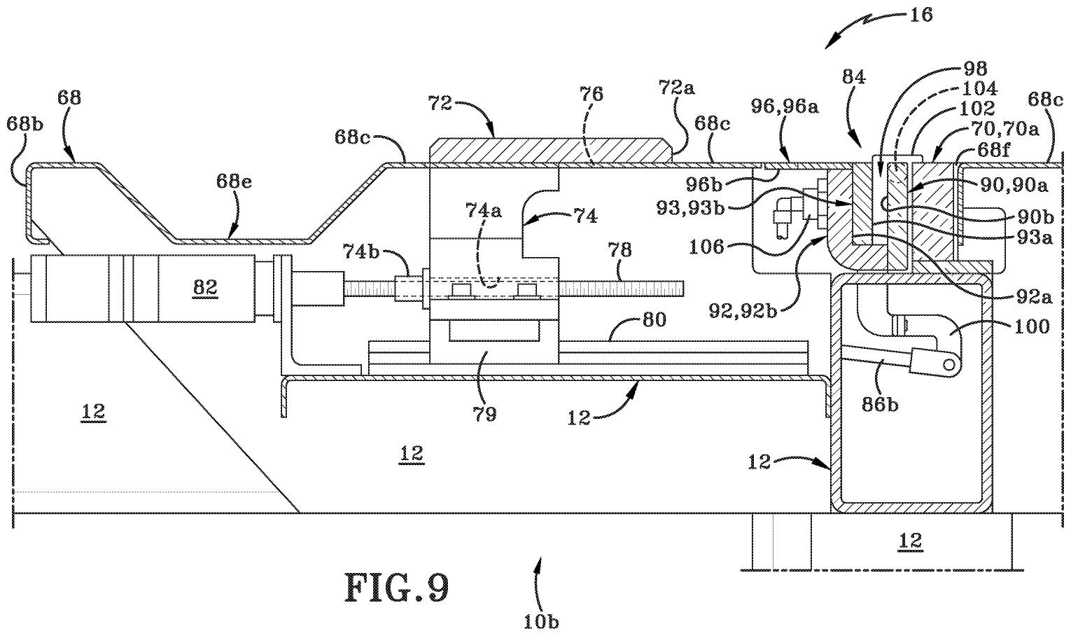

A lower weld bar 70 (FIGS. 9-17) is rigidly mounted on frame 12 in such a way that an upper surface 70a thereof is accessible through gap 68f and is substantially flush with central region 68c. Lower weld bar 70 is operatively engaged with user interface 26 and is configured to heat up to a desired temperature for a predetermined time. This will discussed later herein.

A fabric position stop 72 is provided to permit an operator to set a length of fabric that is positioned on the upper surface of lower housing 16. As best in FIG. 1, fabric position stop 72 is an elongate movable plate that may extend for substantially the entire length of central region 68c, i.e., from proximate left end support 18 to proximate right end support 20. Fabric position stop 72 comprises a generally rectangular body having a front face 72a (FIG. 9) oriented substantially parallel to the longitudinal axis of welding machine 10 and thereby parallel to first trough 68d and second trough 68e. Fabric position stop 72 is fixedly mounted to one or more vertically-oriented plates 74 that each extend at least partially through a laterally-oriented aperture 76 (FIG. 8) defined in central region 68c. Each plate 74 defines a bore 74a therethrough and through which a threaded rod 78 is received. A threaded follower 74b is engaged with rod 78 proximate a rear region of some of the plates 74 as shown in FIG. 9. A guide block 79 is operatively engaged with each plate 74 and the guide block 79 is configured to matingly engage with a guide rail 80 mounted on frame 12. An actuator, such as motor 82, is operatively engaged with threaded rod 78. Motor 82 is mounted on frame 12 and is activated to move threaded rod 78 laterally through bore 74a of some of the plates 74. If motor 82 rotates rod 78 in a first direction, fabric position stop 72 is caused (by rod 78) to move forwardly along guide rail 80 towards front end 68a of central region 68c. If motor 82 rotates rod 78 in a second direction, fabric position stop 72 is caused (by rod 78) to move rearwardly along guide rail 80 and away from front end 68a of central region 68c. Motor 82 is activated by an operator entering commands into user interface 26. When fabric position stop 72 moves across central region 68c in a first direction, the length of fabric that is able to be positioned on central region 68c is reduced. When fabric position stop 72 is moved across central region 68c in a second direction, the length of fabric that is able to be positioned on central region 68c is increased. It will be understood that actuators other than motor 82 may be utilized to move fabric position stop 72. For example, in other instances the operator may simply pull or push the fabric position stop 72 along central region 68c in the desired direction.

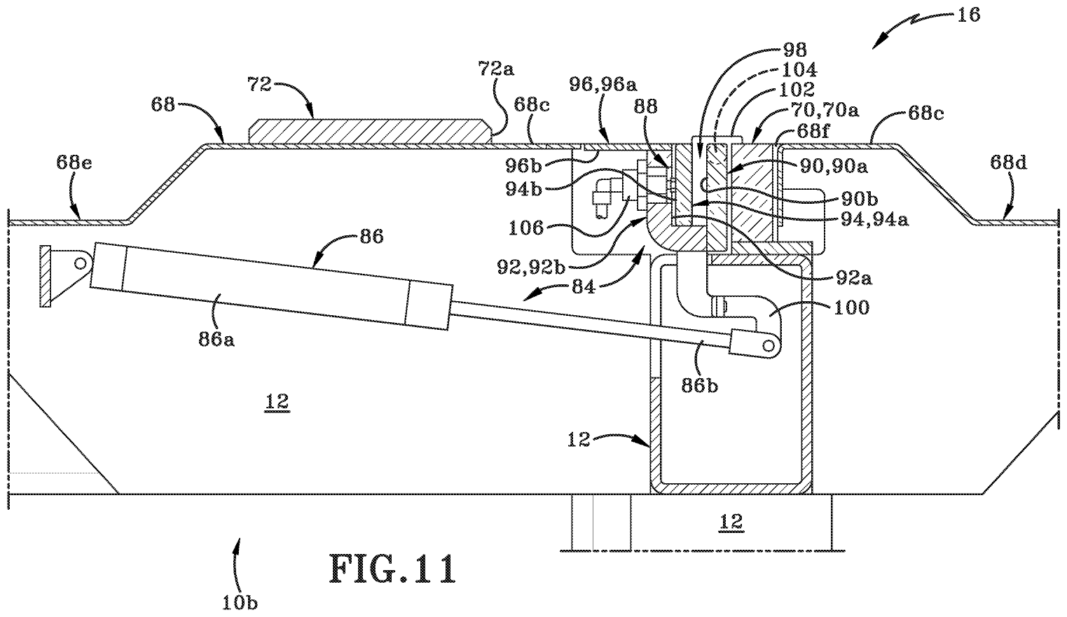

As shown in FIG. 11, a lower folding assembly, generally indicated by the reference number 84, is provided on lower housing 16. Lower folding assembly 84 includes one or more actuators 86 that are mounted on frame 12 and are configured to engage a gripper mechanism 88. As illustrated and described herein, each actuator 86 is a pneumatic cylinder 86a and piston 86b. It will be understood, however, that in other instances the actuators may be electric or hydraulically operable.

Gripper mechanism 88 comprises a plurality of elongate, longitudinally-extending plates that are engaged with each other as will be described hereafter. As shown in FIGS. 9-17, gripper mechanism 88 includes a front plate 90, a rear plate 92, a plurality of intermediate plates 93, a plurality of clamping plates 94, and a top plate 96. All of the front plate 90, rear plate 92, intermediate plates 93, clamping plates 94, and top plate 96 are oriented substantially parallel to first trough 68d and second trough 68e. Front plate 90, rear plate 92, and top plate 96 may all be of substantially the same length as each other and are oriented between left end support 18 and right end support 20. Each intermediate plate 93 is an elongate plate that does not extend from left end support 18 to right end support 20. Instead, the intermediate plates 93 shorter in length and are spaced at intervals from each other along the length of rear plate 92. A gap (not numbered) is defined between adjacent intermediate plates 93. Each clamping plate 94 also does not extend from left end support 18 to right end support 20. Instead, each one of the plurality of clamping plates 94 is located in one of the gaps between adjacent intermediate plates 93. The clamping plates 94 are therefore located at intervals from each other along the length of rear plate 92.

Front plate 90 is substantially rectangular in cross-section and planar along its length, having a front surface 90a and a rear surface 90b. Rear plate 92 is substantially “L-shaped” in cross-section, having a front surface 92a and a rear surface 92b. Each intermediate plate 93 is substantially rectangular in cross-section and planar along its length, having a front surface 93a and a rear surface 93b. Each clamping plate 94 is substantially rectangular in cross-section and planar along its length, having a front surface 94a and a rear surface 94b. Top plate 96 is substantially rectangular in cross-section and planar along its length, having an upper surface 96a and a lower surface 96b.

A first end of the rear plate 92 is welded to the lower surface 96b of top plate 96. A second end of rear plate 92 is welded to rear surface 90b of front plate 90. The rear surface 93b of each intermediate plate 93 is welded to the front surface 92a of rear plate 92. The rear surface 94b of each clamping plate 94 is located adjacent the front surface 92a of rear plate 92. A gap 89 is defined between the rear surface 90b of front plate 90 and the front surfaces 93a, 94a of the intermediate plates 93 and the clamping plates 94, respectively. Top plate 96 is located such that a side edge thereof is flush with front surface 92a of rear plate 92 and the rest of the top plate 96 extends rearwardly beyond the rear surface 92b of rear plate 92. Front plate 90, rear plate 92, intermediate plates, and top plate 96 are welded to one another or are otherwise secured together and therefore move in unison as will be described later herein. Clamping plates 94 are capable of being selectively moved forwardly and rearwardly within gap 98 and relative to rear surface 90b of front plate 90. Clamping plates 94 are also capable of moving in unison with front plate 90, rear plate 92, intermediate plates 93, and top plate 96.

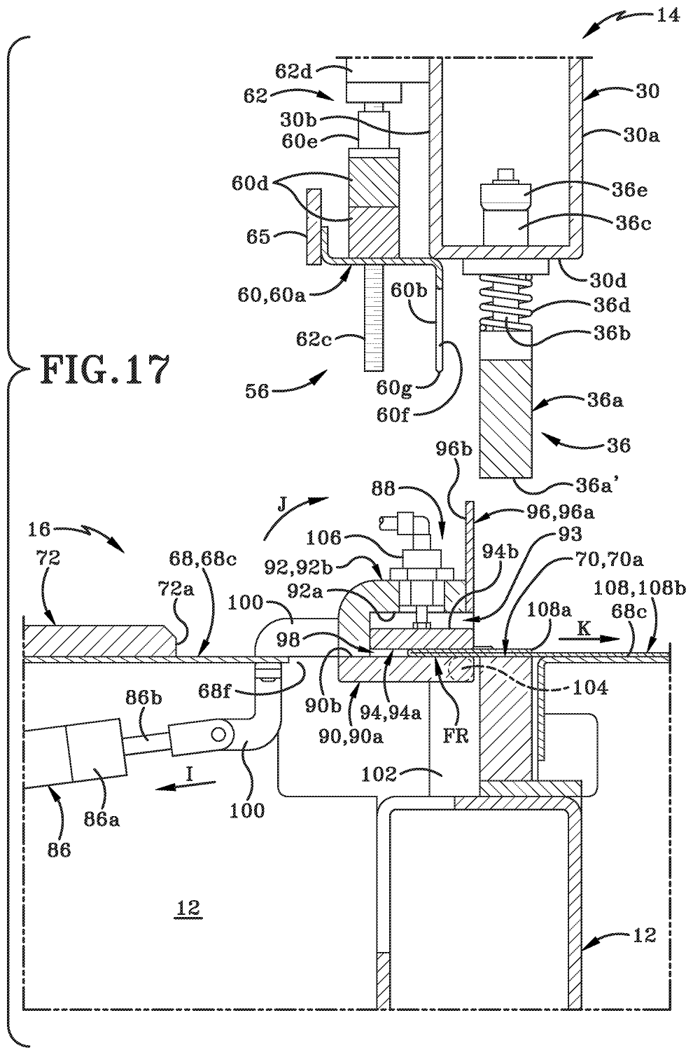

A linkage 100 (FIG. 11) secures rear plate 92 of gripper mechanism 88 to actuator 86. In particular, linkage 100 secures rear plate 92 to piston 86b of actuator 86. Gripper mechanism 88 further includes a pair of pivot blocks 102 (FIG. 9) and a pair of pivot shafts 104. One pivot block 102 is mounted to frame 12 proximate each of front plate 90. A pivot shaft 104 extends between each pivot block 102 and one end of front plate 90. Front plate 90 and any other components operatively engaged therewith are able to be pivoted about an axis that extends along the two spaced apart pivot shafts 104. In particular, front plate 90 is able to be pivoted by actuator 86 from a first position shown in FIG. 9 to a second position shown in FIG. 17 and then back again to the first position. Front plate 90 is pivoted about the axis extending along pivot shafts 104 when actuators 86 are activated. When front plate 90 is pivoted, the rear plate 92, intermediate plates 93, clamping plates 94, and top plate 96 are pivoted in unison with front plate 90.

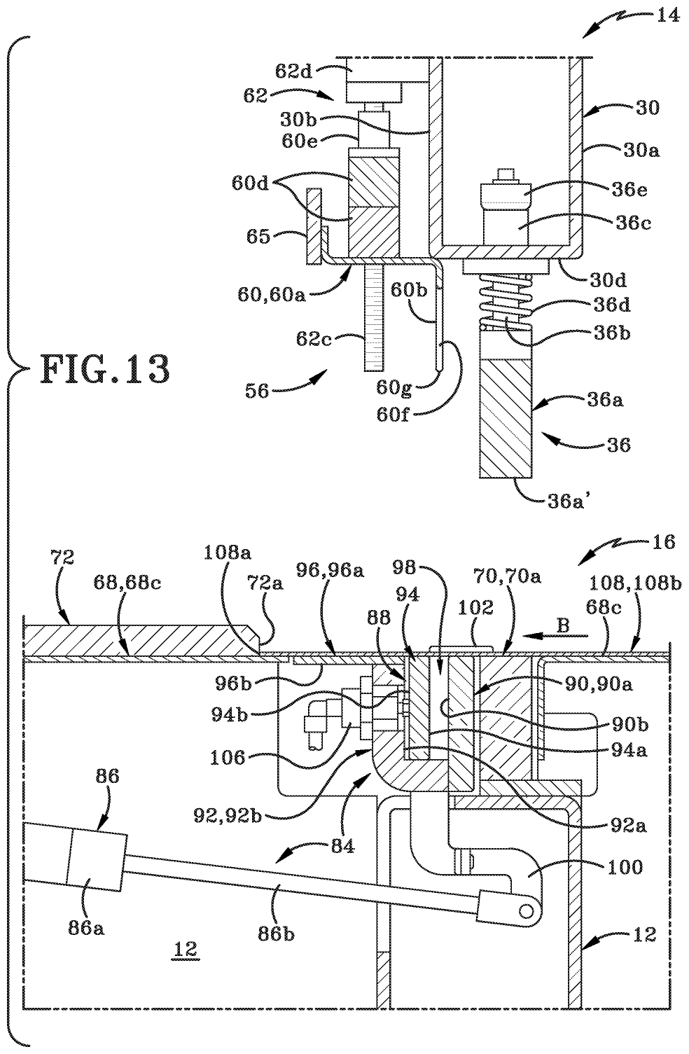

Prior to gripper mechanism 88 being actuated to pivot front plate 90 from the first position to the second position, top plate 96 is oriented so that it is flush with central region 68c (FIG. 9) and flush with upper surface 70a of lower weld bar 70. Fabric introduced into welding machine and placed on the upper surface of lower housing 16 can therefore extend over central region 68c, top plate 96 and upper surface 70a of lower weld bar 70 (FIG. 13). When gripper mechanism 88 is actuated and front plate 90 is pivoted to the second position, top plate 96 is oriented at right angles to central region 68c. This is illustrated in FIG. 17.

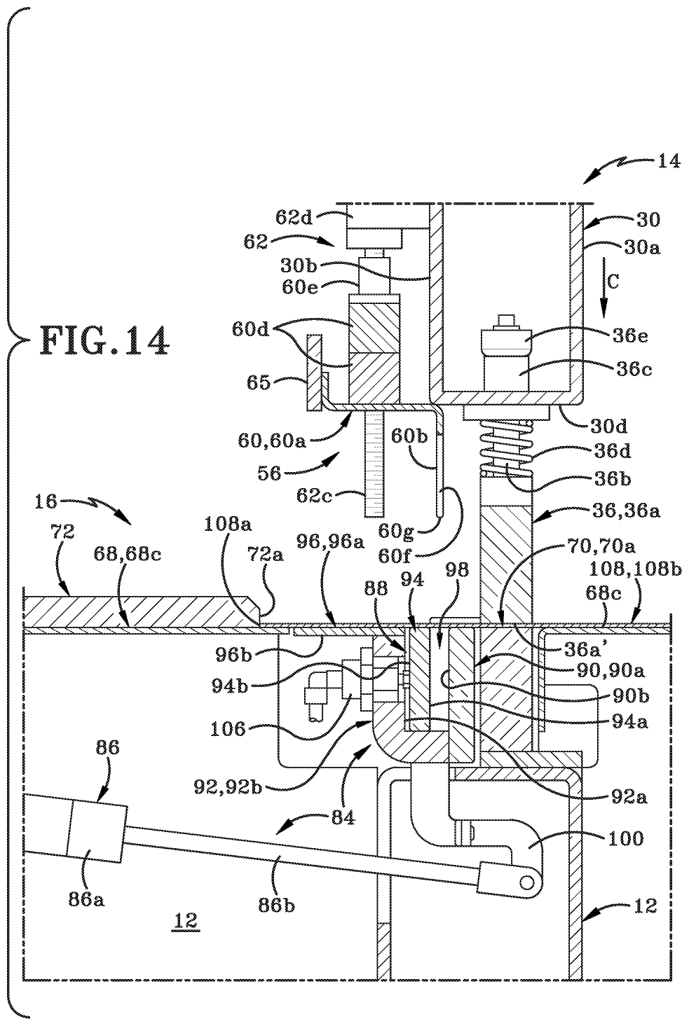

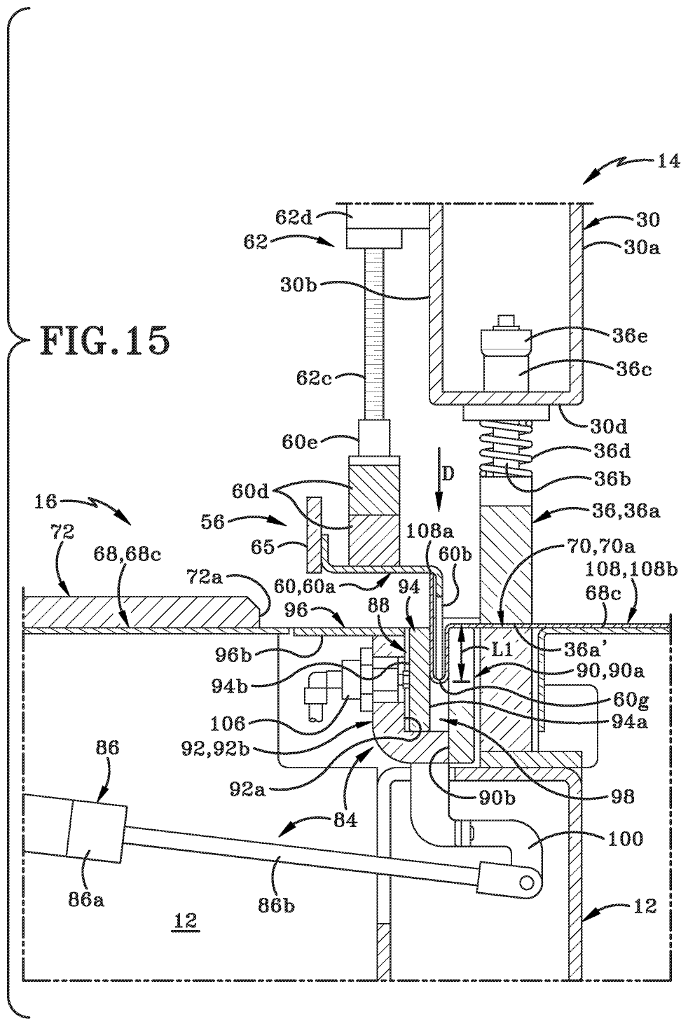

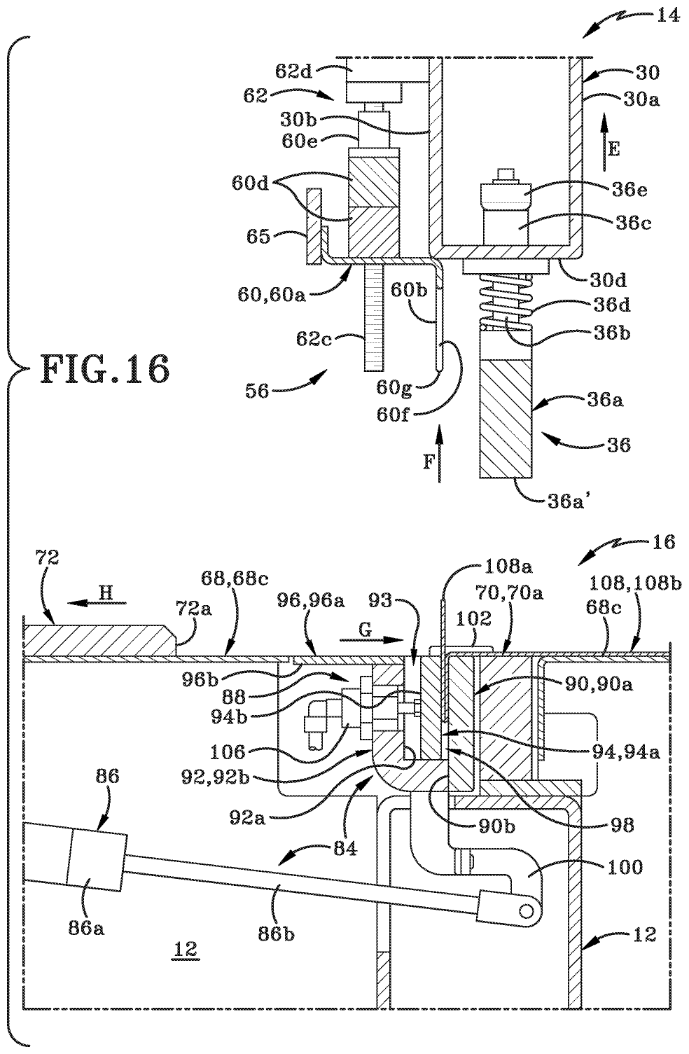

Gripper mechanism 88 further includes one or more pin cylinders 106 that are engaged with rear plate 92 and with each clamping plates 94. Each pin cylinder 106 may be a single acting, spring return pin cylinder. In particular, each pin cylinder may have a 16 mm bore with a 10 mm stroke, i.e., a 19/32 inch bore with a 25/66 inch stroke. Each pin cylinder 106 may include a push-in air fitting elbow that is threaded. As can be seen by comparing FIGS. 16 and 14, pin cylinder(s) 106 are utilized to selectively move each clamping plates 94 forwardly and rearwardly toward and away from front plate 90. In particular, pin cylinder(s) 106 selectively push clamping plate(s) 94 away from front surface 92a of rear plate 92 and towards rear surface 90b of front plate 90. Alternatively, pin cylinder(s) 106 pull clamping plates 94 away from rear surface 90b of front plate 90 and towards front surface 92a of rear plate 92. The effect of the push/pull motion of pin cylinders 106 on clamping plates 94 is that the gap 98 defined between front surface 94a of clamping plate 94 and rear surface 90b of front plate 90 is selectively narrowed or widened. FIG. 15, for example, shows the gap 98 at its maximum width between front surface 94a of clamping plate 94 and rear surface 90b of front plate 90. After actuation of pin cylinder 106, the width of the gap 98 is reduced and this can be seen in FIG. 16. The reason for altering the size of gap 98 will be discussed later herein.

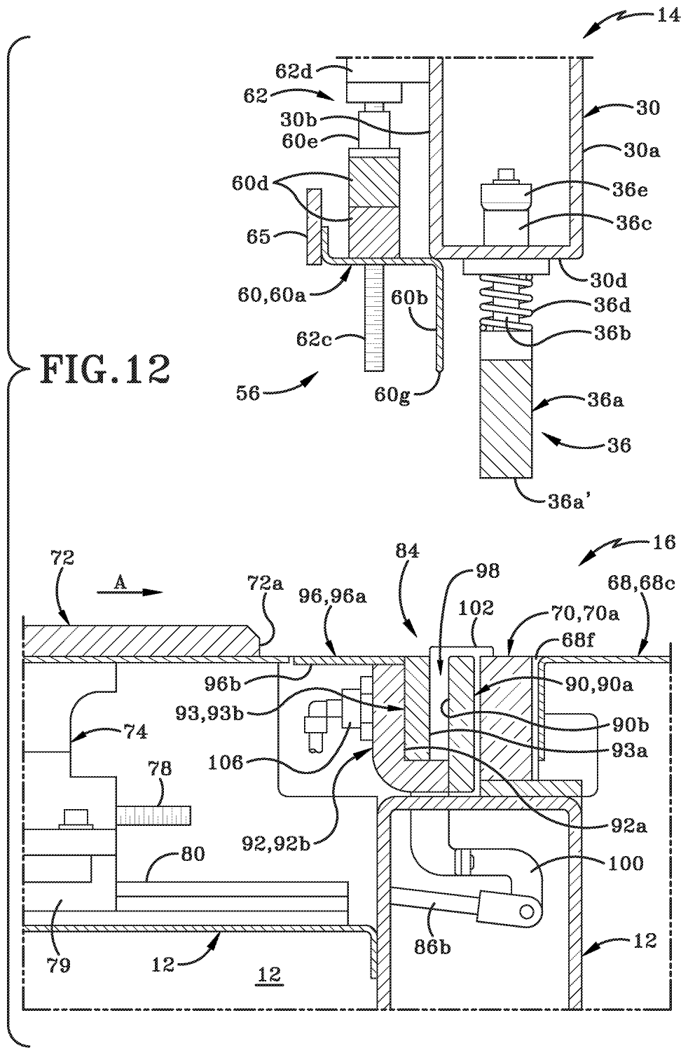

Welding machine 10 is used in the following manner. A length of fabric 108 to be welded is placed in front trough 68d. The operator will determine how much fabric 108 needs to be utilized in a fold and will adjust the position of fabric position stop 72 accordingly. The location of fabric position stop 72 on central region 68c may be changed by the operator entering the appropriate parameters into the welding machine 10 utilizing user interface 26. FIG. 12 shows fabric position stop 72 moving along central region 68c in the direction of arrow “A” and toward front end 68a of welding table 68.

The operator will then grasp a free end of fabric 108 (which includes edge 108a) and will draw the same rearwardly in the direction of arrow “B” and toward rear trough 68e (shown in FIG. 13). The movement is from front trough 68d towards fabric position stop 72. When edge 108a abuts front face 72a of fabric position stop 72, as is shown in FIG. 13, the operator will place magnets or some other restraining component on a section of upper surface 108b of fabric 108 resting on lower housing 16 and so that fabric 108 will not shift on lower housing 16.

The operator will enter further operating information into user interface 26 and this will cause upper welding assembly 36 to move downwardly toward lower housing 16 in the direction of arrow “C” (FIG. 14). This downward movement causes upper weld bar 36a to come into contact with the upper surface 108b of fabric 108, clamping the fabric 108 between lower end 36a′ of upper weld bar 36a and upper end 70a of lower weld bar 70. As is evident from FIG. 14, edge 108a of fabric 108 remains in abutting contact with front face 72a of fabric position stop 72.

The operator will enter further information into user interface 26 and this will cause folding assembly 56 to move downwardly relative to upper welding assembly 36 and thereby cause pusher plate 60b to move downwardly toward central region 68c. The downward movement of folding assembly 56 is shown by arrow “D” in FIG. 15. Downward movement of folding assembly 56 continues until pusher plate 60b enters gap 98 defined between front plate 90 and clamping plate 94. It will be understood that the operator may select the depth to which pusher plate 60b will enter gap 98. The depth “L1” has been set for the welding machine 10 illustrated in FIG. 15. In particular, the depth “L1” is measured from the axis or rotation (i.e., pivot 104) to a tip 60g of pusher plate 60. If the operator wanted a wider fold or pocket in the end product, the depth to which folding assembly 56 will travel, and particularly the depth to which pusher plate 60b will travel, is set so that the depth is greater than “L1”. If the operator wants a narrower fold or pocket in the end product, the depth to which the pusher plate 60b of folding assembly 56 will travel is set to be less than “L1”. It will be understood that in some examples, the pusher plate 60b may be a changeable component and the operator can select which pusher plate 60b to secure to welding machine 10 based on the depth of the pocket or fold that is desired.

Preferably, the distance on central region 68c from gap 98 to front face 72a of fabric position stop 72 is greater than the depth “L1” to which pusher plate 60b is moved downwardly into gap. This relationship will help to ensure that when the folded material is rotated, as will be described later herein with reference to FIG. 17, a portion of the folded material extends forwardly beyond the opening to gap 98 and is therefore available to be contacted and thereby welded by upper and lower weld bars 36, 70.

In a next step, shown in FIG. 16, upper welding assembly 36 is moved upwardly in the direction of arrow “E” and folding assembly 56 is moved upwardly with and relative to upper welding assembly 36 in the direct of arrow “F”. Additionally, pin cylinders 106 are actuated to move clamping plate 64 forwardly toward front plate 90 in the direction of arrow “G”, thus progressively narrowing gap 98. Forward movement in the direction of arrow “G” is continued until clamping plate 94 and front plate 90 clamp the two layers of fabric 108 between them. (Fabric position stop 72 may be withdrawn in the direction of arrow “H” for the next step in the process.)

FIG. 17 shows actuator 86 withdrawing piston 86b back into cylinder 86a, i.e., in the direction of arrow “I”. Withdrawal of piston 26 causes linkage 100 to pivot gripper assembly 88 through 90° about the axis extending along pivot rods 64 and in the direction of arrow “J. The rotation of gripper assembly 88 in the direction of arrow “J” in turn causes the folded region of the fabric, which is identified as “FR” to rotate forwardly in the direction of arrow “K” and rest on the upper surface 108b of fabric 108. The folded region “FR” remains clamped between clamping plate 94 and front plate 90.

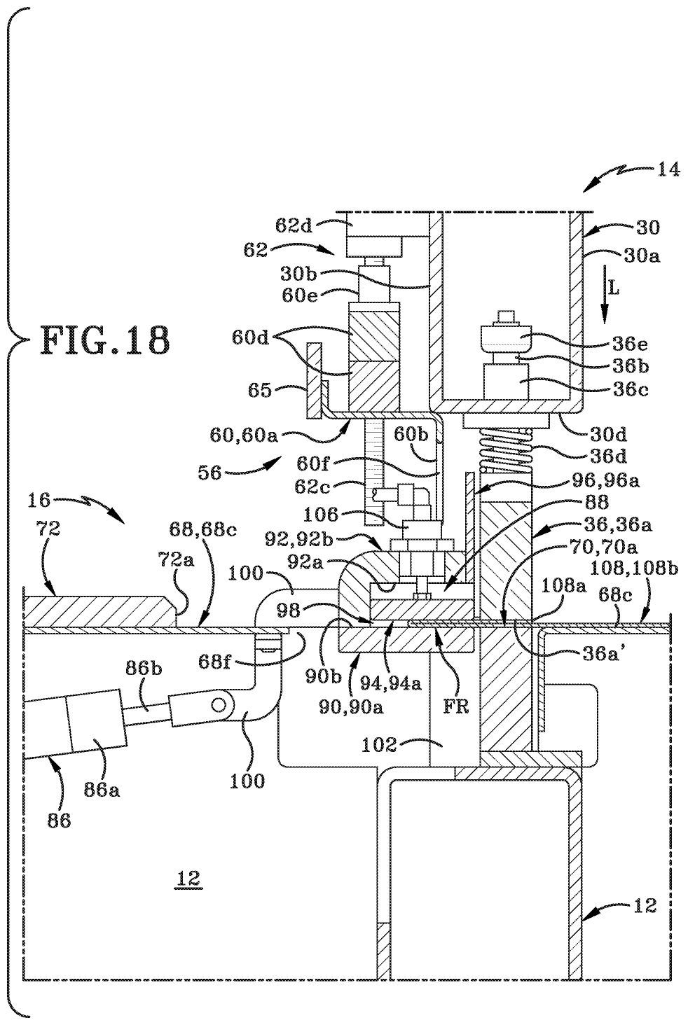

Upper welding assembly 36 is lowered once again in the direction of arrow “L” (FIG. 18) until upper weld bar 36a presses downwardly onto a portion of the folded region “FR” located on upper end 32a of lower weld bar 70. It should be noted that pusher plate 60b includes a series of U-shaped cutouts 60f (FIG. 3B) to enable the pusher plate 60b to be moved downwardly over the pin cylinders 106 when upper welding assembly 36 is lowered to perform a welding operation. Once lower end 36a′ of upper weld bar 36 is in abutting contact with a portion of the folded region “FR”, the upper and lower weld bars 36, 70 are heated to an appropriate welding temperature for the particular fabric 108. Downward pressure is also applied by upper weld bar 36. The heat and pressure is maintained on the clamped portion of folded region “FR” for a pre-selected period of time.

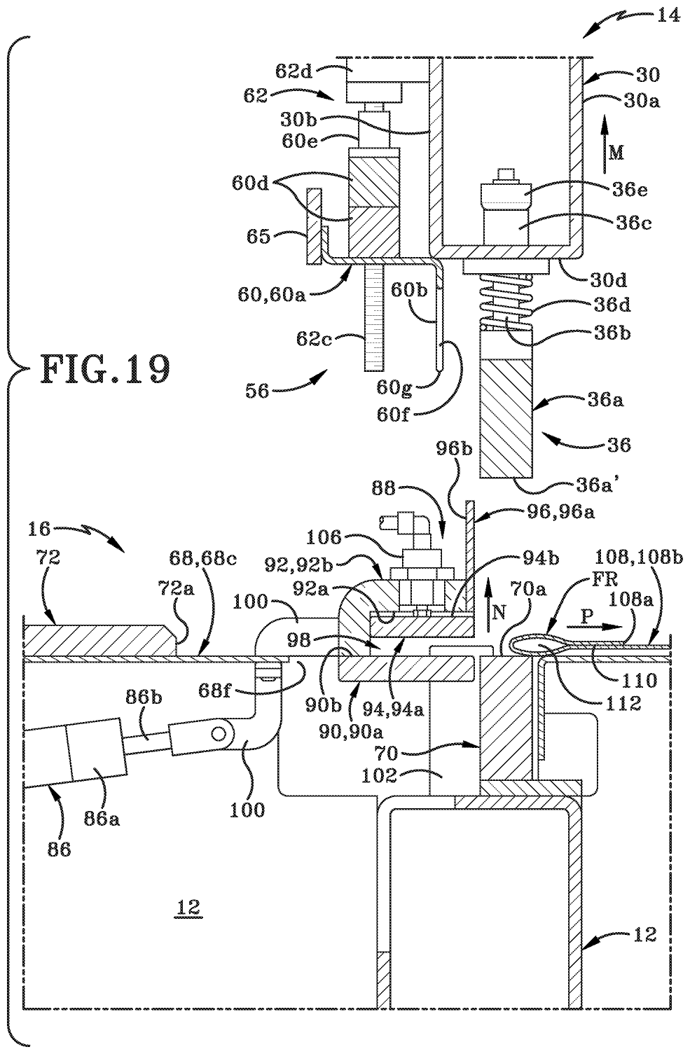

Once a weld 110 has been formed (FIG. 19), then upper welding assembly 36 is raised in the direction of arrow “M” away from lower weld bar 70. Additionally, pin cylinders 106 are activated to withdraw clamping plate 94 toward rear plate 92 and in the direction of arrow “N”. The movements in the directions of arrows “M” and “N” may happen in any order or substantially simultaneously. The withdrawal of clamping plate 94 releases the now-welded fabric 108 from gripper assembly 88. The welded fabric 108, which includes a pocket 112 may be removed from central region 68c of welding machine 10, in the direction indicated by arrow “P”.

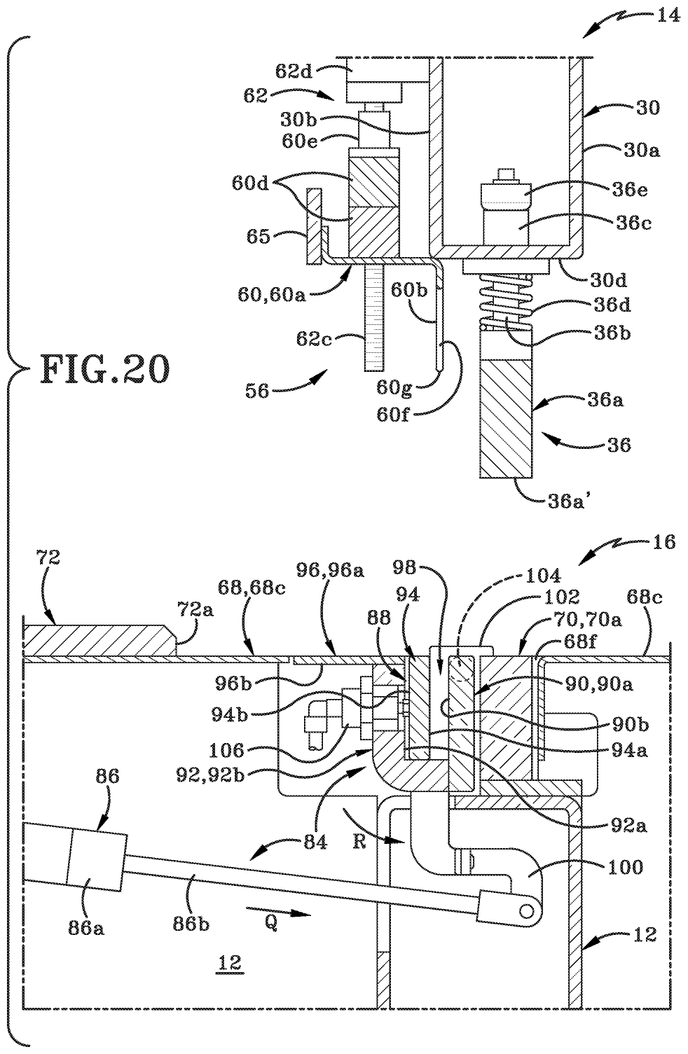

FIG. 20 shows piston rod 86b of actuator 86 being extended outwardly from cylinder 86a in the direction of arrow “Q”. The motion of piston rod 86b causes rotation of gripper assembly 88 in the direction indicated by arrow “R”. This motion causes gripper assembly 88 to rotate back into its first position (or neutral position) where top plate 96 is once again flush with upper end 70a of lower weld bar 70.

While not illustrated herein, it will be understood that welding machine 10 may be used to create a hem in a sheet of fabric. This is accomplished by lowering the upper weld bar 36 but not lowering the folding assembly 56. The folding assembly 56 will remain in a location where no part of the assembly extends below the lower end 36a″ of upper weld bar 36a when spring 36b is fully compressed, i.e., when downward force has been applied to upper weld bar 36a. Creation of the hem is accomplished by folding an end portion of a sheet of fabric back on itself and temporarily securing that folded or overlapped region in place. The fabric sheet is then inserted into the gap between the upper housing 14 and lower housing 16 and so that the fold-line is aligned along the rear end of the lower weld bar 70. The exact position for the fold-line can be set by switching on a laser beam on the welding machine 10 and then aligning the fold-line along the laser beam. (The laser beam may be set to fall vertically over the rear end of the lower weld bar 70.) The upper beam 30 is then lowered as described earlier herein to bring the upper weld bar 36 into contact with the overlapped region of the sheet of fabric. One or both of the upper weld bar 36 and lower weld bar 70 are heated and a downward force is applied by the upper weld bar 36 to create a weld. The area where the weld is created is the hem of the sheet of fabric.

Additionally, while not illustrated herein, it will be understood that welding machine 10 may also be able to create a seam between two separate pieces of fabric. Again, this operation requires that the folding assembly 56 not be lowered relative to upper beam 30. The seam is created by placing inserting a first end of a first piece of fabric into the gap between upper housing 14 and lower housing 16 and moving the first piece of fabric over the central region 68c. The inward movement is continued until a second end of the first piece of fabric is aligned generally with the front end of the lower weld bar 70. A first end of a second piece of fabric can then be inserted between the upper housing 14 and lower housing 16 and the second piece of fabric can be moved inwardly until it overlaps a portion of the first piece of fabric. The exact position for the first end of the second piece of fabric can be set by switching on a laser beam and aligning the first end of the second piece of fabric along the laser beam. (The laser beam may be set to fall vertically over the rear end of the lower weld bar 70.) The upper weld bar 36 can then be lowered into contact with the overlapped region of the first and second pieces of fabric. One or both of the upper weld bar 36 and lower weld bar 70 can be heated and downward force is applied by the upper weld bar 36 to the overlapped region after application of the heat to form the weld. If desired, a length of bonding tape may be applied between the first piece of fabric and the second piece of fabric in the region where the second piece of fabric will overlap the first piece. The bonding tape is applied prior to laying the second piece of fabric over the first piece.

Still further, welding machine 10 may be able to secure two pieces of fabric together by simply overlapping two regions of the two pieces of fabric and then welding them together by lowering the upper weld bar 36a, applying heat to the overlap followed by pressure. The welding machine 10 may also be used to secure an overlay over a piece of fabric by aligning the perimeter of the overlay material with the perimeter of the piece of fabric and welding wherever securement between the two materials is desired. Again, both of the aforementioned operations are performed by only lowering the upper weld bar 36a and keeping the folding assembly 56 in the non-extended position.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A machine for welding sheets of a plastic material, said welding machine comprising:
a housing;
a lower weld bar fixedly secured to the housing such that an upper end of the lower weld bar is flush with a work surface provided on the housing;
an upper weld bar secured to the housing a distance above the lower weld bar; wherein the upper weld bar is vertically movable up and down relative to the lower weld bar;
a vertically-oriented gap defined in the work surface proximate the lower weld bar; and
a pusher plate mounted proximate the upper weld bar; said pusher plate being selectively movable up and down relative to the upper weld bar; and wherein said pusher plate is vertically aligned with the gap and is selectively receivable in the gap.

2. The welding machine according to claim 1, wherein the gap is selectively variable in width.

3. The welding machine according to claim 1, further comprising a gripper assembly mounted to the housing below the work surface; and wherein the gap is defined in the gripper assembly between a front plate and a clamping plate; wherein the front plate and clamping plate are oriented parallel to each other and at right angles to the work surface; and wherein the clamping plate is movable relative to the front plate.

4. The welding machine according to claim 3, further comprising an actuator operatively engaged with the front plate; and wherein the front plate is pivotally engaged with the work surface; and wherein the actuator is selectively operable to move the front plate between a first vertical position and a second horizontal position.

5. The welding machine according to claim 4, further comprising a rear plate spaced from the front plate and fixedly engaged therewith, wherein a space is defined between the front plate and the rear plate; and wherein the clamping plate is located in the space.

6. The welding machine according to claim 5, wherein the actuator pivots the rear plate, the front plate, and the clamping plate in unison.

7. The welding machine according to claim 3, further comprising one or more first actuators engaged with the clamping plate, said one or more actuators being operable to move the clamping plate one of toward the front plate and away from the front plate and thereby change a width of the gap.

8. The welding machine according to claim 1, further comprising an upper beam provided on the housing; wherein the upper weld bar is located in the upper beam and wherein the welding machine further comprises a translation mechanism operatively engaging the pusher plate to the upper beam, wherein the translation mechanism selectively raises and lowers the pusher plate relative to the upper beam.

9. The welding machine according to claim 1, further comprising a fabric position stop provided on the work surface, said fabric position stop being selectively horizontally movable across the work surface toward and away from the lower weld bar.

10. A method of forming a fold or a pocket in a sheet of plastic material, said method comprising:
defining a gap in a work surface;
placing a sheet of plastic material over an opening to the gap, wherein the opening is defined in the work surface;
moving a pusher plate into contact with a region of the sheet of plastic material that extends over the opening;
moving the pusher plate inwardly into the gap; and
creating a fold in the sheet of plastic material as the pusher plate moves inwardly into the gap.

11. The method as according to claim 10, wherein:
the defining of the gap comprises defining a vertically-oriented gap in the work surface; and
the providing of the pusher plate comprises providing a vertically-oriented pusher plate that is aligned with the vertically-oriented gap.

12. The method as according to claim 10, wherein the defining of the gap comprises:
providing a front plate having a front surface and a rear surface that are oriented at right angles to the work surface;
providing a clamping plate having a front surface and a rear surface that are oriented at right angles to the work surface; and the gap is defined between the rear surface of the front plate and the front surface of the clamping plate; and wherein the method further comprises:
inserting the pusher plate between the front surface of the clamping plate and the rear surface of the front plate.

13. The method as according to claim 12, further comprising:
inserting the pusher plate into the gap when the gap is set at a first width;
withdrawing the pusher plate from the gap when the fold has been created in the sheet of plastic material; and
reducing the first width of the gap to a second width; and
clamping the fold between the front plate and the clamping plate.

14. The method as according to claim 13, wherein the reducing of the first width of the gap includes:
activating one or more actuators engaged with the clamping plate; and
moving the clamping plate toward the front plate.

15. The method as according to claim 14, wherein the moving of the clamping plate toward the front plate includes keeping the clamping plate parallel to the front plate.

16. The method as according to claim 13, further comprising:
rotating the clamping plate, the front plate, and the fold in the sheet of plastic material from a vertical orientation to a horizontal orientation.

17. The method as according to claim 16, further comprising:
placing a portion of the fold that extends outwardly from the gap onto an upper surface of the sheet of plastic material and over a lower weld bar;
moving an upper weld bar into contact with the portion of the fold; and
heat-welding the portion of the fold to the upper surface of the sheet of plastic material.

18. The method as according to claim 12, further comprising:
determining a depth of the pusher plate into the gap relative to an axis of rotation of the front plate; and
selecting the depth of the pusher plate so that when rotation of the front plate occurs, a portion of the fold extends outwardly beyond an end wall of the front plate.

19. The method as according to claim 10, further comprising:
abutting an edge of the sheet of plastic material on the work surface against a face of a fabric position stop prior to moving the pusher plate into the gap.

20. The method as according to claim 19, further comprising:
adjusting a location of the fabric position stop on the work surface prior to abutting the edge of the sheet of plastic material against the end face.
